(19) United States
(12) Patent Application Publication
(10) Pub. No.: US 2004/0197178 A1
(43) Pub. Date: Oct. 7, 2004

(54) Lifting boom useable with a forklift

(76) Inventors: James Osterloh, W. Richland, WA (US); Timothy Martin, Pasco, WA (US)

Correspondence Address: SHELDON & MAK, 9th Floor, 225 South Lake Avenue, Pasadena, CA, 91101, US

(21) Appl. No.: 10/406,934

(22) Filed: Apr. 3, 2003

(51) Int. Cl. B66F 9/06

(52) U.S. Cl. 414/607

(57) ABSTRACT

A lifting boom useable with a forklift having a lifting mechanism includes an attachment plate and a boom assembly. The attachment plate is used to attach the boom assembly to the forklift. The boom assembly includes an elongate lifting beam which is swivelably attached to one end of the boom assembly about a vertical axis. The boom assembly optionally includes a swivel lock for alternatively locking and unlocking the ability of the lifting beam to swivel about the vertical axis. A clamp is positioned at either end of the lifting beam. The clamps are optionally hydraulically operated.

### FIELD OF THE INVENTION

This invention relates generally to lifting booms useable with a forklift having a lifting mechanism, and more particularly, to lifting booms containing a lifting beam swivelably attached to a boom assembly and having clamps to engage and lift loads that weigh up to one ton or more.

### BACKGROUND OF THE INVENTION

The use of lifting devices with a forklift to lift heavy objects is known in the manufacturing and construction industries. A typical lifting device is attached to a forklift through an attachment plate, and further comprises a boom assembly, and a lifting beam. The boom assembly contains a long bolt that holds the lifting beam and allows the beam to freely swivel about a vertical axis. Such lifting devices typically contain clamps on each end of the lifting beam for engaging and lifting a load. The clamps are manually engaged and disengaged.

The problem with such forklift lifting boom assemblies is that they do not have a mechanism to lock and unlock the swivel of the lifting beam. Another problem with such assemblies is that the clamps have to be engaged and disengaged manually. The limitations of such apparatuses are apparent when the lifting beam has to be positioned directly over a container that is to be lifted. The forklift operator can only control the up and down movement of the lift, and does not have any control over the position of the lifting beam, as the lifting beam is free to swivel about its vertical axis. Also, since the clamps on the ends of the lifting beam have to be engaged to or disengaged from the load manually, the forklift operator can only engage or disengage the clamps by leaving the forklift or with assistance of one or more workers. Such limitations of the previous apparatuses require two additional operators to position, clamp and unclamp the lifting beam. The use of additional operators to lift a load is expensive and adds to the cost of operation of the forklift.

Accordingly, there is a need for a forklift lifting device that is capable of alternatively locking and unlocking the ability of the lifting beam to swivel about the vertical axis and that contains a mechanism allowing automated operation of the clamps on the ends of the lifting beam.

### SUMMARY

The invention satisfies this need. The invention is a lifting boom useable with a forklift having a lifting mechanism. This lifting boom comprises (a) an attachment plate for attachment to the lifting mechanism of a forklift; (b) a boom assembly having an attachment plate end and a swivel end, the attachment plate end being attached to the attachment plate; (c) an elongate lifting beam swivelably attached to the swivel end of the boom assembly about a vertical axis, the beam having a first end and a second end; and (d) at least one clamp disposed proximate to both the first end and the second end of the lifting beam. In one embodiment, the clamps are hydraulically operated clamps. In another embodiment, the apparatus further comprises a swivel lock for alternatively locking and unlocking the ability of the lifting beam to swivel about the vertical axis.

### DRAWINGS

These features, aspects and advantages of the present invention will become better understood with regard to the following description, appended claims and accompanying figures where:

FIG. 1 is a perspective view of a forklift and a lifting boom having features of the invention.

FIG. 2 is a plan view of a lifting boom having features of the invention.

FIG. 3 is a frontal view of the lifting boom illustrated in FIG. 2.

FIG. 4 is a perspective view of the lifting boom illustrated in FIG. 3.

FIG. 5 is a cross-sectional side view of the lower boom assembly illustrated in FIG. 2, taken along line 5-5.

FIG. 6 is an exploded view of a swivel assembly useable in the invention.

FIG. 7 is a perspective view of the swivel assembly illustrated in FIGS. 1 and 6.

FIG. 8 is a side view of lynch pin useable in the invention.

### DETAILED DESCRIPTION

The following discussion describes in detail two embodiments of the invention and several variations of those embodiments. This discussion should not be construed, however, as limiting the invention to those particular embodiments. Practitioners skilled in the art will recognize numerous other embodiments as well.

The invention is a lifting boom 10 for lifting loads weighing up to one ton and more. This lifting boom 10 comprises an attachment plate assembly 12, a boom assembly 14, a lifting beam 16, and at least one clamp 18 disposed on either end of the lifting beam 16. The lifting boom 10 is suitable for attachment to the lifting assembly 20 of a large industrial forklift 22, such as a 12,000 pound model forklift manufactured by Hyster Company of Greenville, N.C. In the embodiment illustrated in the drawings, the attachment plate assembly 12 comprises an attachment plate 24, two lugs 26 and 28 and a cavity 30. The attachment plate 24 is attached to the lifting assembly 20 of a forklift 22. The attachment plate 24 is typically made up of a rectangular metal plate, but any other suitable material or shape may be used. The attachment plate 24 contains an upper lug 26 and a lower lug 28, as shown in FIG. 4. In the embodiment illustrated in the drawings, the attachment plate 24 contains a cavity 30. The lugs 26 and 28 are made of metal, typically of steel. Each of the lugs 26 and 28 connects to the attachment plate 24 at a 90° angle. The attachment plate 12 is clamped to the lifting assembly 20 of the forklift 22 by lugs 26 and 28. The upper lug 26 is welded to the attachment plate 24, while the lower lug 28 is bolted to the attachment plate 24. Lateral shifting of the attachment plate assembly 12 relative to the lifting assembly 20 is prevented by jam bolts 37. Thus, attachment and removal of the lifting boom 16 is facilitated by the upper lug 26 which carries the weight of the lifting boom 16 and the removable lower lug 28 that holds the attachment assembly 12 to the lifting assembly 20.

In the embodiment illustrated in the drawings, the boom assembly 14 comprises an upper boom assembly 38 and a lower boom assembly 40. The upper boom assembly 38 is typically connected to both the attachment plate 24 and to the lifting beam 16. The upper boom assembly 38 has an attachment plate end 42, which is welded to the attachment plate 24, and a swivel end 44, which is connected to the lifting beam 16. In the embodiment illustrated in the drawings, the upper boom assembly 38 is comprised of an upper boom beam 46, an elongate pipe 48, and a swivel assembly 50. The upper boom beam 46 is welded to the attachment plate 24, and extends horizontally from the lower part of the attachment plate 24. The end 54 of the upper boom beam 46 distal to the attachment plate 24 is vertically radiused to accept the upper sleeve 56 of the swivel assembly 50. The upper boom beam 46 is welded to the upper sleeve 56 of the swivel assembly 50. The elongate pipe 48 extends downwardly from the upper portion of the attachment plate 24. The function of this pipe 48 is to vertically stiffen the upper boom beam 46 by acting as a tension member. The end of this pipe 48 distal to the attachment plate 24 is welded to the upper boom beam 46 at an acute angle. The end of the pipe 48 adjacent to the plate 24 is welded to the plate 24.

The swivel assembly 50 is shown in detail in FIG. 6. This swivel assembly 50 is positioned along a vertical axis 51. In the embodiment illustrated in the drawings, the swivel assembly 50 comprises an upper sleeve 56, a lower sleeve 58 and a swivel shaft 60. The upper sleeve 56 is a cylinder typically made of steel, which is typically welded to the end of the upper boom assembly 38. The upper sleeve 56 has an upper end 62 and a lower end 64. The swivel shaft 60 is typically made out of low carbon cold roll carbon steel. The lower sleeve 58 is a cylinder typically made of steel, and it is pinned to the swivel shaft 60 with a bolt 66, a lockwasher 68, and a nut 70, as shown in FIG. 6. The lower sleeve 58 has an upper end 72 and a lower end 74.

In the embodiment illustrated in the drawings, the swivel assembly 50 further comprises an upper swivel bushing 76 and a lower swivel bushing 78. The upper swivel bushing 76 and the lower swivel bushing 78 are typically made of oil impregnated sintered bronze (“oil lite bronze”) and are fit into the upper end 62 and the lower end 64 of the upper sleeve 56, respectively. The swivel shaft 60 passes through the swivel bushings 76 and 78, maintaining alignment of the lower boom assembly 40 with the upper boom assembly 38. A thrust bearing 80, typically made of brass, is disposed on top of the upper swivel bushing 76 and fits between the upper swivel bushing 76 and either a weight sensor 82 or a replacement spacer (not shown), depending on whether or not the optional weight sensor 82 is used. In one embodiment, the thrust bearing 80 has an off center round groove so as to provide an off center lubrication annulus (not shown). In the embodiment illustrated in the drawings, the weight sensor 82 is provided by a load cell.

The weight sensor 82 is an optional feature of the invention that allows the forklift operator to read a digital display (not shown) mounted on the dashboard of the forklift 22, indicating the total lifting boom load 34. The load cell range is chosen so that it will include the weight of the load 34 to be lifted by the lifting boom 10. The range typically is 0-5000 lbs. When there is no load 34 on the boom 10, the digital display reads zero. A load cell useable in the invention is an Omegadyne Model # LC8450-313-5K load cell, made by Omegadyne, Inc. of Stamford, Conn. Alternatively, other commercially available load cells, compatible with the swivel assembly 50, may be used.

If no weight sensor 82 is installed, a load cell replacement spacer 86 is present. This load cell replacement spacer 86 is typically made of steel. The thrust bearing 80 is fitted with a standard Zerk fitting to apply lubrication. A plain castle nut 88 having multiple indentations 89 at one end is disposed on top of either the load cell replacement spacer 86 or the weight sensor 82, depending on which option is used. A spring pin 90 passes through two of the indentations of the plain castle nut 88. During assembly, the castle nut 88 is only tightened enough to eliminate the free play, but not tight enough to hinder the swivel motion in any way. An end cap 92 is welded to the lower end of the swivel shaft 60.

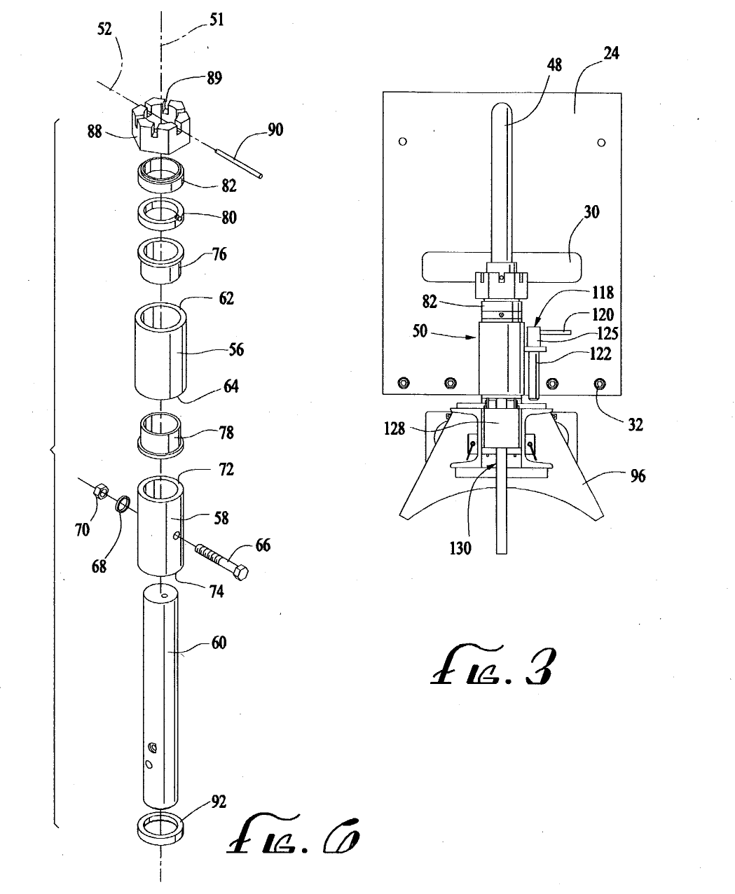

In the embodiment illustrated in the drawings, the lower boom assembly 40 comprises a lifting beam 16, at least one ship channel 94, at least one load saddle 96, at least one hydraulic ram 98, a hydraulic accumulator 100, and at least one clamp 18. The lower boom assembly 40 is illustrated in FIG. 5.

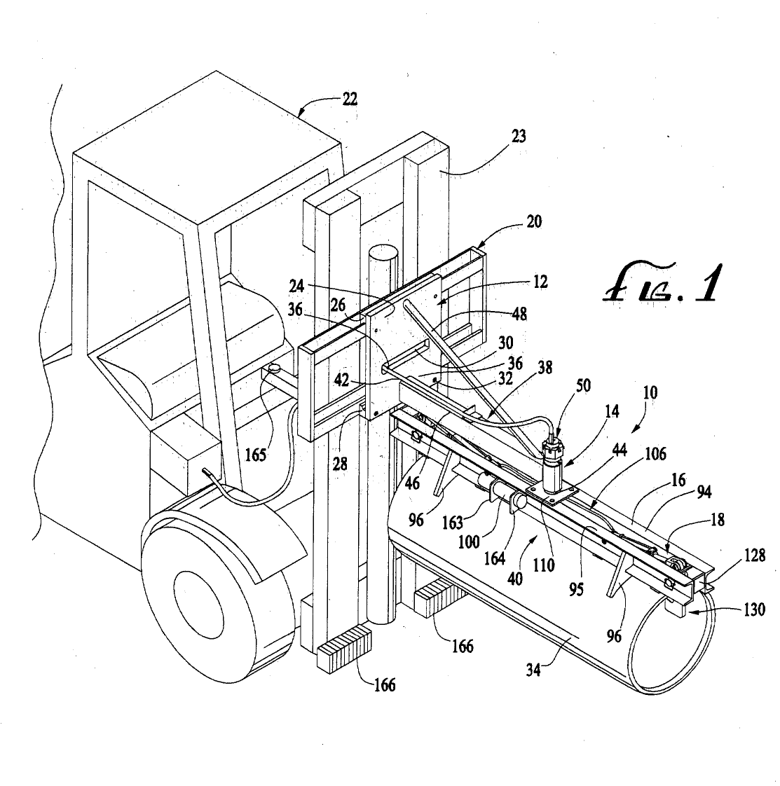

The lifting beam 16 is an elongate beam having a first end 102 and a second end 104. In the embodiment illustrated in the drawings, the lifting beam 16 contains two ship channels 94 and 95. These channels 94 and 95 are joined to each other using two end plates 128, as shown in FIG. 1. The end plates 128 are typically made of steel. In the embodiment illustrated in the drawings the ship channels 94 and 95 provide the lifting beam 16 with a cavity 106, the cavity extending longitudinally along the beam's length, as shown in FIG. 1. The cavity 106 has a width that is sufficient to allow the through passage of the lower part of the swivel assembly 50, as shown in FIG. 5. Two swivel assembly mount plates 108 and 110 are welded to the lifting beam, one plate 108 from above the beam, and one plate 110 from below the beam. These plates 108 and 110 are seen in FIG. 4. Each mount plate 108 and 110 has a circular cavity 112 and 113, the circular cavities having a diameter that is typically equal to the width of the lifting beam cavity 106. The cavities of the mount plates 112 and 113 are aligned with the cavity 106 of the lifting beam 16 so as to allow the through passage of the lower sleeve 58 of the swivel assembly 50. The lower sleeve 58 of the swivel assembly 50 is at least partially disposed within the lifting beam 16 and both of the swivel mount plate cavities 112 and 113. In the embodiment illustrated in the drawings, the lower sleeve 58 is free to rotate about a vertical axis 51. This sleeve 58 is typically welded to both of the swivel assembly mount plates 108 and 110.

The swivel assembly 50 allows the lifting beam 16 to be rotated about the vertical axis 51 of the swivel shaft 60. In the embodiment illustrated in the drawings, the swivel assembly 50 is positioned along a vertical axis 51. Because the lower sleeve 58 of the swivel assembly 50 is welded to the lifting beam 16, the lifting beam 16 is only capable of movement along with the lower sleeve 58, and the angle between the swivel assembly 50 and the lifting beam 16 does not change. This prevents unwanted wobbling of the lifting beam 16 while the load 34 is being lifted by the lifting boom 10.

In the embodiment illustrated in the drawings, the top swivel assembly mount plate 108 is square-shaped, and contains four cavities 114, each disposed proximate to one corner of the plate 108. In the embodiment illustrated in the drawings, the lifting beam 16 contains four correspondingly sized cavities 116. The top mount plate 108 is positioned with respect to the lifting beam 16 so that its one large cavity 112 and four smaller cavities 114 are aligned with the corresponding cavities 106 and 116 of the lifting beam 16.

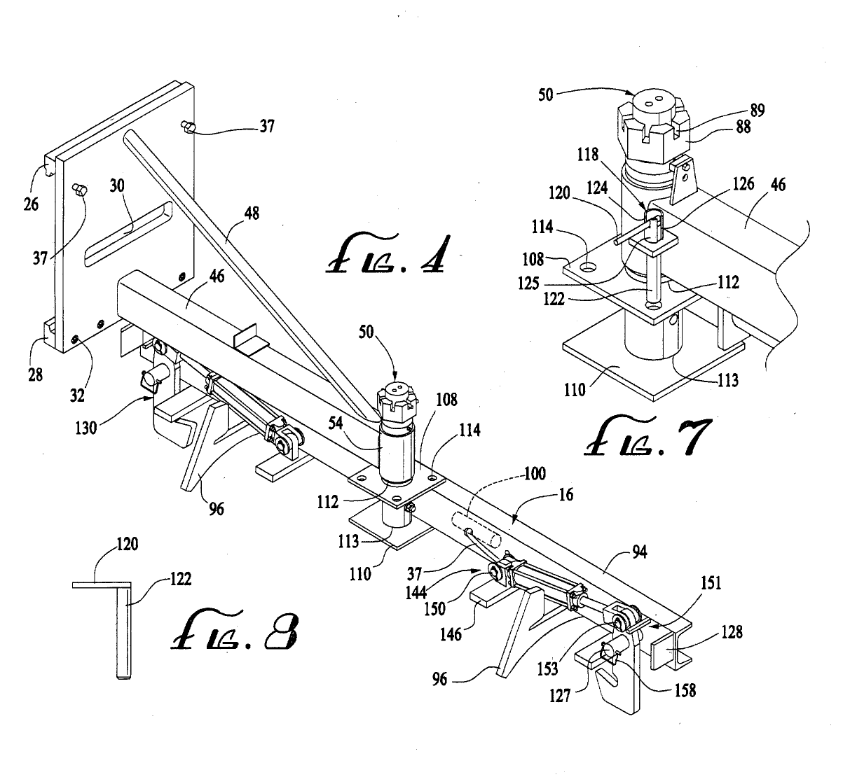

In the embodiment illustrated in the drawings, a swivel lock 118 is provided by a simple lynch pin 120 which is mounted to a cylindrical pin 122 that is attached to the upper boom assembly 38. This swivel lock 118 is shown in detail in FIG. 7. The housing 125 has two slots 124 and 126 cut in it. If the pin 120 is lifted and placed in the shallower of the slots 124, it is prevented from dropping into the cavity 114, drilled in the top swivel assembly mount plate 108 and the cavity 116 of the lifting beam 16. This allows free rotation of the lower boom assembly 40. If the pin 120 is placed into the deeper slot 126, it is allowed to drop into one of the four cavities 114 and into one of the four corresponding cavities 116, thereby locking the lifting beam 16 in any one of four positions that are either perpendicular to or in-line with the upper boom assembly 38. Thus the swivel lock 118 prevents unwanted swiveling of the lifting beam 16.

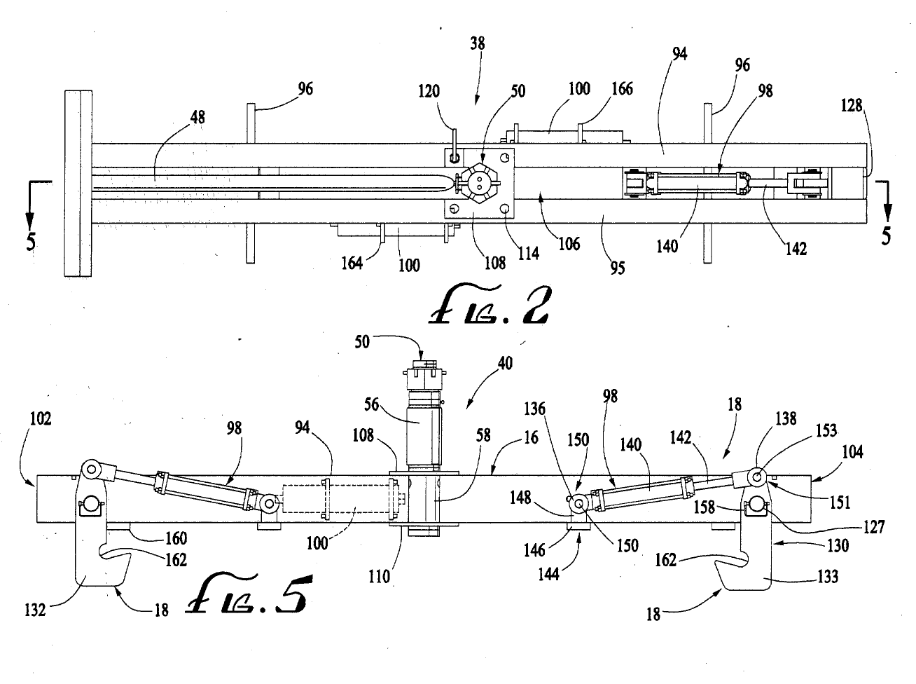

In the embodiment illustrated in the drawings, the lifting beam 16 contains two load saddles 96, each disposed proximate to either the first 102 or the second 104 end of the beam 16, as shown in FIG. 4. Each load saddle 96 is typically manufactured from metal, and is welded to the lifting beam 16. The shape of each load saddle 96 is typically complementary to the shape of the load 34. In the embodiment illustrated in the drawings, where the load 34 is cylindrical in shape, the shape of each load saddle 96 is semi-circular, with the radius being appropriately sized to accommodate the cylindrical load 34, as shown in FIG. 3. Thus, the saddles 96 prevent unwanted roll of the load 34.

In the embodiment illustrated in the drawings, the lifting beam 16 contains two hydraulic rams 98 and two clamps 18, each disposed proximate to either the first end 102 or the second end 104 of the beam 16, as shown in FIG. 5. In the embodiment illustrated in the drawings, each clamp 18 is provided by a hook assembly 130. The hook assembly 130 of the illustrated embodiment comprises a hook 132. Each hook 132 is swivelably attached to the beam 16 by an attachment pin 127. The hydraulic rams 98 and the hook assemblies 130 are attached to the lifting beam 16 and connected to each other. The ship channels 94 and 95 of the lifting beam 16 typically house the hydraulic rams 98 and the top portions of the hook assemblies 130, as shown in FIG. 1.

A hydraulic ram 98 is shown in FIG. 5. The ram has a mount plate end 136 and a hook assembly end 138. The ram 98 has a piston-like shape, containing a sleeve 140 that houses a rod 142. The rod 142 is capable of extending away from the sleeve 140. The extension of the rod 142 occurs due to hydraulic pressure supplied to the hydraulic ram 98 by hydraulic lines 36. This pressure originates from the auxiliary hydraulic circuit (not shown) on the forklift 22. The rod 142 is proximate to the hook assembly end 138 of the hydraulic ram 98, and the sleeve 140 is proximate to the mount plate end 136. Movement of the rod 142 creates rotation of the hook 132 because the hydraulic ram 98 is connected to the hook assembly 130.

Each hydraulic ram 98 is attached to the lifting beam 16 using a mount assembly 144. In the embodiment illustrated in the drawings, the mount assembly 144 is comprised of a mount plate 146, a mount 148, and a ram pin assembly 150, all shown in FIG. 5. The mount plate 146 is typically made of metal and rectangular in shape. Part of the top surface of the mount plate 146 is welded to the underside of the lifting beam 16. In the illustrated embodiment, two hydraulic rams 98 and two hook assemblies 130 are attached to the lifting beam 16. Thus, two mount assemblies 144 are used to secure hydraulic rams 98 to the lifting beam 16.

As illustrated in the embodiments illustrated in FIGS. 4 and 5, the ram pin assembly 150 contains a ram pin 153 having one square snap pin 158 disposed proximate to each end of the ram pin 153. The ram pin 153 connecting the hydraulic ram 98 to the hook assembly 130 and the attachment pin 127 connecting the hook assembly 130 to the lifting beam 16 allow for rotation of the hook 132. Proximate to each hook assembly 130, a hook stop 160 is welded to the lifting beam 16. In the embodiment illustrated in the drawings, two hooks 132 and 133 and two hook stops 160 and 161 are used. Each hook stop 160 and 161 controls the degree of rotation of each hook 132 and 133. The hooks 132 and 133 are shown in detail in FIG. 5. As can be seen from this figure, the two hooks 132 and 133 have differing distances between attachment pin 127 and ram pin 153. In the embodiment illustrated in the drawings, the distance between attachment pin 127 and ram pin 153 is greater for hook 132 than for hook 133. Because of this configuration, hook 132 will always rest against stop 160 when engaging a load. Hook 133, on the other hand, will “float.” The distances from each hook stop 160 and 161 to each end of the beam are not equal, as shown in FIG. 5. Each hook 132 and 133 has to be positioned at its specific hook stop 160 and 161, observing pre-defined distances to the ends of the lifting beam 16, as shown in FIG. 5

Each hook assembly 130 has a failsafe mechanism 163 associated with it. The failsafe mechanism 163 prevents the hooks 132 and 133 from opening and releasing the load 34 in case of accidental loss of hydraulic pressure to the hooks 132 and 133. The fail-safe mechanism 163 could be provided by metallic springs (not shown), configured to be large enough to support the desired load weight. In the embodiment illustrated in the drawings, the failsafe mechanism 163 is provided by two hydraulic accumulators 100. Each accumulator 100 is attached to the lifting beam via an accumulator bracket assembly 164, as shown in FIG. 1. The two accumulators 100 are disposed proximate to the center of the beam 16. In the illustrated embodiment, the accumulators 100 are located on the opposing sides of the beam 16, as shown in FIG. 2. Each accumulator 100 contains a hydraulic line 37 that passes through the lifting beam 16. The hydraulic line 36 extends from each accumulator 100 and attaches to its respective hydraulic ram 98 inside the cavity 116 of the lifting beam 16. In embodiment illustrated in the drawings, each accumulator 100 is charged behind a piston with approximately 800-1000 psig of Nitrogen. The pressure from each accumulator 100 is applied to the closing side of each hydraulic ram 98, acting as a fail-safe mechanism. In the event that there is failure of the hooks 132 and 133 due to a loss of forklift auxiliary hydraulic circuit pressure, each accumulator 100 will provide its corresponding hydraulic ram 98 with sufficient pressure to keep the load 34 locked into place by the hooks 132 and 133. Absent this hydraulic accumulator 100, the hooks 132 and 133 would unclasp and release the load 34 upon failure of the hydraulic lines 36.

As an optional feature of the invention, the lifting boom 10 contains a level monitor 165 for monitoring the angle at which the beam 16 is disposed with respect to the horizontal. In one embodiment of the invention, this level monitor 165 is a sight glass. The level monitor 165 is positioned on the lifting assembly 20 in order to acquire an accurate reading of the angular position of the load 34. This feature of the invention can be used both to insure that the load 34 is in a perfectly horizontal position, and to achieve a specific angle of the load 34 required by a receptacle (not shown) accepting the load 34.

As illustrated in FIG. 1, the lifting assembly 20 of the forklift 22 can be equipped with bumpers 166. Such bumpers 166 can be used in some operations to index the front of a load 34 to the back of the lifting boom 10.

In operation, the lifting boom 10 of the invention is brought into proximity to the load 34 of interest by a forklift operator. The load 34 can be approached from any orientation because the lifting boom 10 is capable of swiveling about a vertical axis 51 to align property with the orientation of the load 34. Once the forklift operator sets the desired orientation of the lifting boom 10, the lynch pin 120 can be dropped by the forklift operator into any one of the four cavities 114 in the top swivel assembly mount plate 108. This dropping of the pin 120 prevents rotation of the lifting boom 10 about the swivel axis. Once the lifting boom 10 is oriented and locked in longitudinal alignment with the load 34, the forklift operator moves and centers the lifting boom 10 over the load 34. In the absence of the swivel lock 118 mechanism, additional operators would be necessary to maintain the desired orientation of the lifting boom 10, since the lifting boom 10 would normally freely swivel about a vertical axis 51 during the movement of the forklift 22 or during the vertical movement of the lifting boom 10.

The forklift operator subsequently opens the hooks 132 and 133 by using the forklift auxiliary hydraulic controls. Specifically, the pressure in the hydraulic lines 36 is transmitted to the hydraulic rams 98, and the movement of the hydraulic rams 98 moves each hook 132 and 133 in the unclamp, or open position. Once the hooks 132 and 133 are opened, the forklift boom 10 is lowered onto the target load 34 until the load saddles 96 come in contact with the top surface of the load 34. At that point, the operator uses the forklift auxiliary hydraulic controls (not shown) to remove the hydraulic pump pressure from the hydraulic rams 98. The hydraulic accumulators 100 provide the motive force to close the hooks 132 and 133 at that point. Hydraulic pressure from the forklift auxiliary hydraulic system is used only to open the hooks 132 and 133. In the unlikely event that auxiliary system hydraulic pressure is lost to the hydraulic rams 98, the hooks 132 and 133 go to their closed position and stay that way until auxiliary hydraulic system pressure is once again available to overcome accumulator pressure. This design prevents the dropping of the load 34 in case of auxiliary hydraulic system failure. Once the hooks 132 and 133 are locked onto the load 34, the operator may lift the load 34 at that point using the lifting assembly 20 of the forklift 22.

After the load 34 is lifted, the forklift operator, or another worker, may rotate the load 34 by pushing on one end of the load 34. In order to rotate the load 34, the operator will lift the lynch pin 120 from its previous position, thus removing the swivel lock 118. Rotation of the load 34 allows for orienting it in alignment with a receptacle that will accept the load 34. This rotation is possible because the lifting boom 10 is free to swivel about the vertical axis 51. The rotation of the lifting boom 10 requires minimal force because the thrust bearing 80 in the swivel assembly 50 takes the load 34 and is lubricated. The position of the lifting boom 10 can be fixed in any one of four possible positions that are either perpendicular to or in-line with the upper boom assembly 38. The lynch pin 120, which acts as a swivel lock 118, can be again dropped by the forklift operator into any one of the four cavities 114 in the top swivel assembly mount plate 108 to achieve the desired load orientation, and prevent inadvertent rotation of the load 34 about the vertical axis 51 while it is being moved.

Once the load 34 is lifted by the lifting boom 10, if the optional weight sensor 82 is installed, the forklift operator can read a digital display mounted on the dashboard of the forklift 22 that would indicate the total lifting boom load weight. The weight sensor 82 avoids the step of placing the load 34 on a scale to determine its weight, thus minimizing material handling steps.

A typical forklift truck 22 is equipped with a mechanism that allows for tilting of its mast rails 23, thus changing the horizontal position of the load 34. In the embodiment illustrated in the drawings, the forklift boom 10 is free to swivel about its vertical axis 51, and such rotation does not change the horizontal positioning of the load 34 with respect to the ground. In cases where the receptacle of the load 34 requires the load 34 not to be parallel to the ground, the optional level monitor 165 can be used for for monitoring the angle at which the beam 16 is disposed with respect to the ground. By looking at the angle displayed by the level monitor 165, the forklift operator can achieve specific angle of the load 34 required by the load receptacle.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A lifting boom useable with a forklift having a lifting mechanism, the lifting boom comprising:
(a) an attachment plate for attachment to the lifting mechanism of a forklift;
(b) a boom assembly having an attachment plate end and a swivel end, the attachment plate end being attached to the attachment plate;
(c) an elongate lifting beam swivelably attached to the swivel end of the boom assembly about a vertical axis, the beam having a first end and a second end; and
(d) at least one hydraulically operated clamp disposed proximate to both the first end and the second end of the lifting beam.

2. The lifting boom of claim 1 further comprising a swivel lock for alternatively locking and unlocking the ability of the lifting beam to swivel about the vertical axis.

3. The lifting boom of claim 1 further comprising a level monitor for monitoring the angle at which the lifting beam is disposed with respect to the horizontal.

4. The lifting boom of claim 3 wherein the level monitor is a sight glass.

5. The lifting boom of claim 1 further comprising a weight sensor for sensing the weight of an object attached to the lifting beam by the clamps.

6. The lifting boom of claim 1 further comprising at least one hydraulic accumulator operatively connected to the hydraulically operated clamps so as to prevent the clamps from opening in the event of a sudden loss of hydraulic pressure.

7. A lifting boom useable with a forklift having a lifting mechanism, the lifting boom comprising:
(a) an attachment plate for attachment to the lifting mechanism of a forklift;
(b) a boom assembly having an attachment plate end and a swivel end, the attachment plate end being attached to the attachment plate;
(c) an elongate lifting beam swivelably attached to the swivel end of the boom assembly about a vertical axis, the beam having a first end and a second end;
(d) a swivel lock for alternatively locking and unlocking the ability of the beam to swivel about the vertical axis; and
(e) at least one clamp disposed proximate to both the first end and the second end of the beam.

8. The lifting boom of claim 7 further comprising a level monitor for monitoring the angle at which the lifting beam is disposed with respect to the horizontal.

9. The lifting boom of claim 8 wherein the level monitor is a sight glass.

10. The lifting boom of claim 7 further comprising a weight sensor for sensing the weight of an object attached to the lifting beam by the clamps.

11. A lifting boom useable with a forklift having a lifting mechanism, the lifting boom comprising:
(a) an attachment plate for attachment to the lifting mechanism of a forklift;
(b) a boom assembly having an attachment plate end and a swivel end, the attachment plate end being attached to the attachment plate;
(c) an elongate lifting beam swivelably attached to the swivel end of the boom assembly about a vertical axis, the beam having a first end and a second end;
(d) a swivel lock for alternatively locking and unlocking the ability of the beam to swivel about the vertical axis;
(e) at least one hydraulically operated clamp disposed proximate to both the first end and the second end of the beam; and
(f) at least one hydraulic accumulator operatively connected to the hydraulically operated clamps so as to prevent the clamps from opening in the event of a sudden loss of hydraulic pressure.

12. The lifting boom of claim 11 further comprising a level monitor for monitoring the angle at which the lifting beam is disposed with respect to the horizontal.

13. The lifting boom of claim 12 wherein the level monitor is a sight glass.

14. The lifting boom of claim 11 further comprising a weight sensor for sensing the weight of an object attached to the lifting beam by the clamps.

15. A lifting boom useable with a forklift having a lifting mechanism, the lifting boom comprising:
(a) an attachment plate for attachment to the lifting mechanism of a forklift;
(b) a boom assembly having an attachment plate end and a swivel end, the attachment plate end being attached to the attachment plate;
(c) an elongate lifting beam swivelably attached to the swivel end of the boom assembly about a vertical axis, the beam having a first end and a second end;
wherein the swivel assembly is connected to the lifting beam such that the the lifting beam is free to rotate only about the vertical axis, and the angle of the beam relative to the swivel assembly is constant.
